(19) United States
(12) Patent Application Publication
(10) Pub. No.: US 2014/0368605 A1
(43) Pub. Date: Dec. 18, 2014

(54) Remote Conference Control Method, Terminal Equipment, MCU, and Video Conferencing System

(71) Applicant: Huawei Technologies Co., Ltd., Shenzhen (CN)

(72) Inventor: Chang Liu, Shenzhen (CN)

(21) Appl. No.: 14/476,122

(22) Filed: Sep. 3, 2014

Related U.S. Application Data
(63) Continuation of application No. PCT/CN2013/071897, filed on Feb. 26, 2013.

(30) Foreign Application Priority Data
Mar. 8, 2012 (CN) 201210059456.6

(51) Int. Cl. H04N 7/15

(52) U.S. Cl. CPC H04N 7/152
USPC 348/14.09

(57) ABSTRACT

A remote conference control method, a terminal equipment, a multipoint control unit (MCU), and a video conferencing system, where the method includes: when a conference joining terminal receives pause conference indication information sent by a multipoint control unit MCU during a process of a video conference, disabling, by the conference joining terminal according to the received pause conference indication information, a media channel of the conference joining terminal, saving channel parameters, and entering a standby or hibernation state; when the conference joining terminal receives resume conference indication information sent by the MCU, enabling, by the conference joining terminal according to the received resume conference indication information and the saved channel parameters, the media channel of the conference joining terminal, and resuming a working state.

### CROSS-REFERENCE TO RELATED APPLICATIONS

This application is a continuation of International Application No. PCT/CN2013/071897, filed on Feb. 26, 2013, which claims priority to Chinese Patent Application No. 201210059456.6, filed on Mar. 8, 2012, both of which are hereby incorporated by reference in their entireties.

### TECHNICAL FIELD

The present invention relates to the field of communication technologies, and in particular, to a remote conference control method, a terminal equipment, an MCU (multipoint control unit), and a video conferencing system.

### BACKGROUND

As a type of remote conference, a video conference is held between users in two or more locations using a multipoint control unit (MCU), video input and output devices, and audio input and output devices to transmit images and voices in real time.

Currently, when an existing video conference is being held, when a user needs to suspend the conference for an affair (such as a noon break or a meal), only two means can be used: one is to end the conference, wait for the affair to be handled, and reconvene the conference. According to a first means, during a process of ending the conference, because a conference joining site may be called by another conference or site, configuration parameters of the site may be changed, which therefore affects the reconvening of the conference, and for a conference on a complex network, such as a hybrid conference of a cascading or multi-line type, an operation of reconvening the conference are complex, which affects user experience; the other is to continue the conference, let a conference participant handle the affair while conference joining devices operate properly, and let the conference participant continue the use after handling the affair. A second means occupies too many bandwidth resources and also causes power waste by the conference joining devices.

A first prior art example suspends a conference by sending a blue screen or a black screen, or implementing muting. The prior art can hide only an image of a local end and images of the other sites are still visible; muting is only oriented to a specific site; furthermore, bandwidth resources are still occupied and all conference joining devices still operate with full power.

A second prior art example uses a defined conference template, in other words, information such as conference parameters are saved before a conference is convened according to a specific format as a parsable file, to facilitate reconvening of the conference after the conference is ended or suspended. A process to reconvene a conference in the prior art is still not simple and convenient enough. Furthermore, when a conference is ended, a problem that a conference joining site may be called by another conference or site still cannot be effectively resolved.

### SUMMARY

Embodiments of the present invention provide a remote conference control method, a terminal equipment, an MCU, and a video conferencing system, so as to resolve a problem in the prior arts that operations are complex or resources are wasted during a process of suspending and resuming a conference remotely.

According to one aspect, an embodiment of the present invention provides a remote conference control method, where the method includes when a conference joining terminal receives pause conference indication information sent by an MCU during a process of a video conference, disabling, by the conference joining terminal according to the received pause conference indication information, a media channel of the conference joining terminal, saving channel parameters, and entering a standby or hibernation state; and when the conference joining terminal receives resume conference indication information sent by the MCU, enabling, by the conference joining terminal according to the received resume conference indication information and the saved channel parameters, the media channel of the conference joining terminal, and resuming a working state.

According to another aspect, an embodiment of the present invention provides a terminal equipment, where the terminal equipment includes a receiver configured to receive pause conference indication information or resume conference indication information from an MCU; a conference suspending unit configured to, when the receiver receives the pause conference indication information from the MCU, disable, according to the received pause conference indication information, a media channel of the current terminal equipment, and enable the current terminal equipment to enter a standby or hibernation state; a memory configured to save channel parameters of a current conference; and a conference resuming unit configured to when the receiver receives the resume conference indication information from the MCU, enable, according to the received resume conference indication information and the channel parameters saved in the memory, the media channel of the current terminal equipment, and resume a working state of the current terminal equipment.

According to still another aspect, an embodiment of the present invention further provides a video conferencing system, where the video conferencing system includes a multipoint control unit and at least three terminal equipment, where the multipoint control unit and the terminal equipment are connected by using a network, where the multipoint control unit includes a receiver configured to receive pause conference request information or resume conference request information; a processor, which includes a construction unit, where the construction unit is configured to construct a pause conference indication according to the pause conference request information received by the receiver; construct a resume conference indication according to the resume conference request information received by the receiver; and a sender configured to send the pause conference indication or the resume conference indication constructed by the construction unit.

According to yet another aspect, an embodiment of the present invention further provides an MCU, where the MCU includes a receiver configured to receive pause conference request information or resume conference request information; a processor, including a construction unit, where the construction unit is configured to construct a pause conference indication according to pause conference request information received by the receiver; construct a resume conference indication according to resume conference request information received by the receiver; and a sender configured to send the pause conference indication or the resume conference indication constructed by the construction unit.

The embodiments of the present invention, compared with the prior arts, bring the following beneficial effects: a conference is suspended instead of being ended and a problem that a conference joining site may be called by another conference or site and configuration parameters of the site are changed does not exist, ensuring successful reconvening of the conference; a pause or resume conference indication is sent to quickly and simply implement conference suspension or resumption, so as to suspend the conference at any time or resume the conference at any time; during suspension of the conference, all media sending or receiving channels are disabled and all conference joining devices enter a standby or hibernation state. In this way, bandwidth resources are not occupied and loss of the conference joining devices is prevented, featuring good usability and high practicality.

### BRIEF DESCRIPTION OF DRAWINGS

To describe the technical solutions in the embodiments of the present invention more clearly, the following briefly introduces the accompanying drawings required for describing the embodiments. The accompanying drawings in the following description show merely some embodiments of the present invention, and a person of ordinary skill in the art may still derive other drawings from these accompanying drawings without creative efforts.

FIG. 1 is a schematic structural diagram of a video conferencing system according to Embodiment 1 of the present invention;

FIG. 2 is a flowchart of implementing a remote conference control method according to Embodiment 2 of the present invention;

FIG. 3 is a flowchart of implementing a remote conference control method according to Embodiment 3 of the present invention;

FIG. 4 is an exemplary diagram of a common conference network according to Embodiment 3 of the present invention;

FIG. 5 is a composition structural diagram of a terminal equipment according to Embodiment 4 of the present invention; and

FIG. 6 shows a composition structure of an MCU according to Embodiment 5 of the present invention.

### DESCRIPTION OF EMBODIMENTS

To make the objectives, technical solutions, and advantages of the present invention more comprehensible, the following further describes the present invention in detail with reference to the accompanying drawings and embodiments. It should be understood that the specific embodiments described herein are merely used to explain the present invention but are not intended to limit the present invention.

To illustrate the technical solutions according to the present invention, illustration is provided below through specific embodiments.

### Embodiment 1

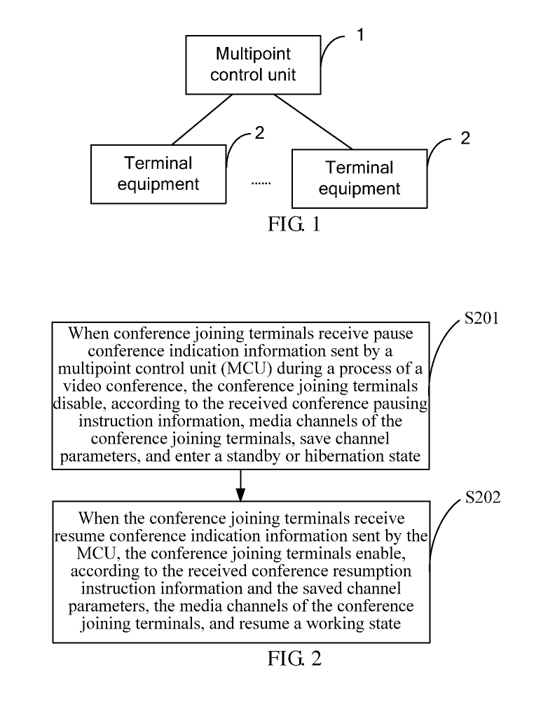

FIG. 1 shows a structure of a video conferencing system according to Embodiment 1 of the present invention. For ease of description, only a part related to this embodiment of the present invention is shown.

The remote conference control method provided in the embodiments of the present invention may apply to the video conferencing system, where the video conferencing system at least includes an MCU 1 and multiple conference joining terminal equipment 2 controlled by the multipoint control unit 1;

The MCU1 is a control core of the video conferencing system. When the number of the conference joining terminal equipment 2 is greater than 2, control by the MCU1 is required. A network is used to connect the MCU1 to the terminal equipment 2 and connect the terminal equipment 2. The MCU1 implements, according to the enterprise standard conference control (IDO) protocol or international standards such as H.221, H.242, H.243, and H.245, exchange and mixing of images and voice, and implements related functions such as control of all sites.

The multipoint control unit 1 includes a receiver configured to receive pause conference request information or resume conference request information; a processor, which includes a construction unit, where the construction unit is configured to construct a pause conference indication according to the pause conference request information received by the receiver; construct a resume conference indication according to the resume conference request information received by the receiver; and a sender configured to send the pause conference indication or the resume conference indication constructed by the construction unit.

Preferably, that the construction unit is configured to construct a pause conference indication according to the pause conference request information received by the receiver, and construct a resume conference indication according to the resume conference request information received by the receiver, is:

the construction unit is configured to determine whether the pause conference request information or the resume conference request information received by the receiver carries a conference identification; if the pause conference request information or the resume conference request information received by the receiver carries a conference identification, acquire information about all conference joining terminals of a conference corresponding to the conference identification; and construct the pause or resume conference indication, where the pause or resume conference indication carries the information about all the conference joining terminals of the conference corresponding to the conference identification; and

the construction unit is configured to determine whether the pause conference request information or the resume conference request information received by the receiver carries an identification of one or more conference joining terminals; and if the pause conference request information or the resume conference request information received by the receiver carries an identification of one or more conference joining terminals, construct the pause or resume conference indication that carries the identification of the one or more conference joining terminals.

Preferably, the processor further includes a hibernation/standby unit configured to after the pause conference indication information is sent to all the terminal equipment, disable a media channel of the current MCU, and save channel parameters, data of the current conference, and states of all the current conference joining terminals, where the channel parameters include parameters of channels connecting the current multipoint control unit to all the terminal equipment and the data of the current conference includes conference parameters of all the terminal equipment.

The terminal equipment 2 includes a receiver configured to receive pause conference indication information or resume conference indication information from the MCU; a conference suspending unit configured to when the receiver receives the pause conference indication information from the MCU, disable a media channel of a current terminal equipment according to the received pause conference indication information, and enable the current terminal equipment to enter a standby or hibernation state; a memory configured to save channel parameters of a current conference; and a conference resuming unit configured to when the receiver receives the resume conference indication information from the MCU, enable the media channel of the current terminal equipment according to the received resume conference indication information and the channel parameters saved in the memory, and resume a working state of the current terminal equipment.

Preferably, the memory is further configured to save conference parameters.

Preferably, the terminal equipment 2 further includes at least one terminal equipment with a suspension permission, where the at least one terminal equipment with the suspension permission has all functions of the terminal equipment 2 and may further be used to send the pause or resume conference request information to the multipoint control unit 1 to enable the MCU1 to send the pause or resume conference indication information to all or a part of the conference joining terminals.

Preferably, the conference suspending unit is configured to when the receiver receives the pause conference indication information from the MCU 1, determine whether an identifier of a conference joining terminal carried in the pause conference indication information is the same as an identifier of the current terminal, or determine whether conference identification information carried in the pause conference indication information is the same as a conference identification of the conference currently joined by the current terminal, or determine whether the conference identification information carried in the pause conference indication information is the same as the conference identification of the conference currently joined by the current terminal and whether the identifier of a conference joining terminal carried in the pause conference indication information is the same as the identifier of the current terminal; if yes, then, disable the media channel of the current terminal equipment according to the received pause conference indication information, and enable the current terminal equipment to enter the standby or hibernation state; and the conference resuming unit is configured to when the receiver receives the resume conference indication information from the MCU 1, determine whether the identifier of a conference joining terminal carried in the resume conference indication information is the same as the identifier of the current terminal, or determine whether the conference identification information carried in the resume conference indication information is the same as the conference identification of the conference currently joined by the current terminal, or determine whether the conference identification information carried in the resume conference indication information is the same as the conference identification of the conference currently joined by the current terminal and whether the identifier of a conference joining terminal carried in the resume conference indication information is the same as the identifier of the current terminal; if yes, then, enable the media channel of the current terminal equipment according to the received resume conference indication information and the channel parameters saved in the memory, and resume the working state of the current terminal equipment.

### Embodiment 2

FIG. 2 shows a process of implementing a remote conference control method provided in Embodiment 2 of the present invention, and the process of the method is described in detail as follows:

In step S201, when conference joining terminals receive pause conference indication information sent by an MCU during a process of a video conference, the conference joining terminals disable the media channel according to the received pause conference indication information, saves channel parameters, and enters a standby or hibernation state.

In this embodiment, the conference joining terminals use a conference control channel during the process of the video conference to receive the pause conference indication information sent by the MCU, where the pause conference indication information is predefined extended conference control information, and the media channel includes a media receiving and sending channel configured to send or receive media code streams; the channel parameters include audio and video formats, selectable audio and video encoding types, audio and video rates, communication rates, and the like.

It should be noted that, after the conference joining terminals receive the pause conference indication information, only the media channels of the conference joining terminals are disabled, the conference control channel for sending or receiving conference control signaling is still enabled, and the MCU and each conference joining terminal uses the conference control channel to maintain normal calls.

In step S202, when the conference joining terminals receive resume conference indication information sent by the MCU, the conference joining terminals enable their media channels according to the received resume conference indication information and the saved channel parameters, and resume a working state.

In this embodiment, the conference joining terminals in the standby or hibernation state use the conference control channel to receive the resume conference indication information sent by the MCU, where the resume conference indication information is predefined extended conference control information.

### Embodiment 3

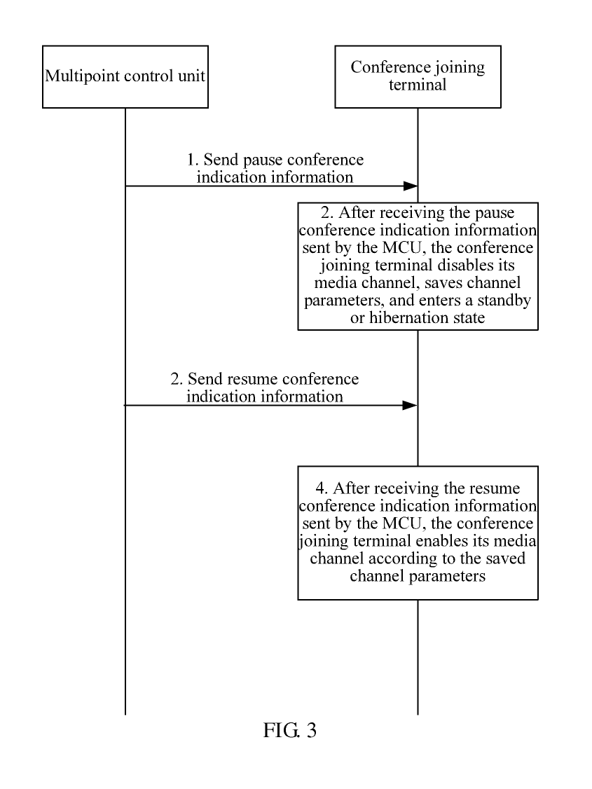

FIG. 3 shows a process of implementing a remote conference control method provided in Embodiment 3 of the present invention, and the process of the method is described in detail as follows:

1. A multipoint control unit (MCU) sends pause conference indication information to conference joining terminals.

In this embodiment, the MCU sends, according to defined extended conference control information, pause or resume conference indication information to each conference joining terminal to implement conference suspension or resumption, where the defined extended conference control information (information according to the enterprise standard conference control (IDO) protocol) includes, but is not limited to, a part shown in Table 1.

TABLE 1

| Extended Conference Control | |
|---|---|
| Information | Value/Remark |
| cmConfCtrlPauseConfInd | 0x29e pause conference indication |
| cmConfCtrlResumeConfInd | 0x300 resume conference indication |
| cmConfCtrlPauseConfReq | 0x610 pause conference request |
| cmConfCtrlResumeConfReq | 0x611 resume conference request |

Preferably, any conference joining terminal that has acquired a suspension permission (such as a chairman permission) may send, at any time, pause conference request information to the MCU. After receiving pause conference request information sent by a conference joining terminal with the suspension permission, the MCU sends the pause conference indication information to all or a part of the conference joining terminals (as shown in FIG. 2). It should be noted that, all the conference joining terminals include the conference joining terminal with the suspension permission.

That a conference joining terminal with the suspension permission among the conference joining terminals sends pause conference request information to the MCU is the conference joining terminal with the suspension permission among the conference joining terminals sends the pause conference request information to the MCU, where the pause conference request information carries conference identification information of a conference that needs to be suspended; or, the conference joining terminal with the suspension permission among the conference joining terminals sends the pause conference request information to the MCU, where the pause conference request information carries an identifier of one or more conference joining terminals for which the conference needs to be suspended; or, the conference joining terminal with the suspension permission among the conference joining terminals sends the pause conference request information to the MCU, where the pause conference request information carries the identifier and conference identification information of the one or more conference joining terminals for which the conference needs to be suspended.

Preferably, the MCU may further preset a suspension time (such as a lunch time) and send the pause conference indication information to all or a part of the conference joining terminals when the preset suspension time elapses.

2. After receiving the pause conference indication information, the conference joining terminals disable their media channels, save channel parameters, and enter a standby or hibernation state.

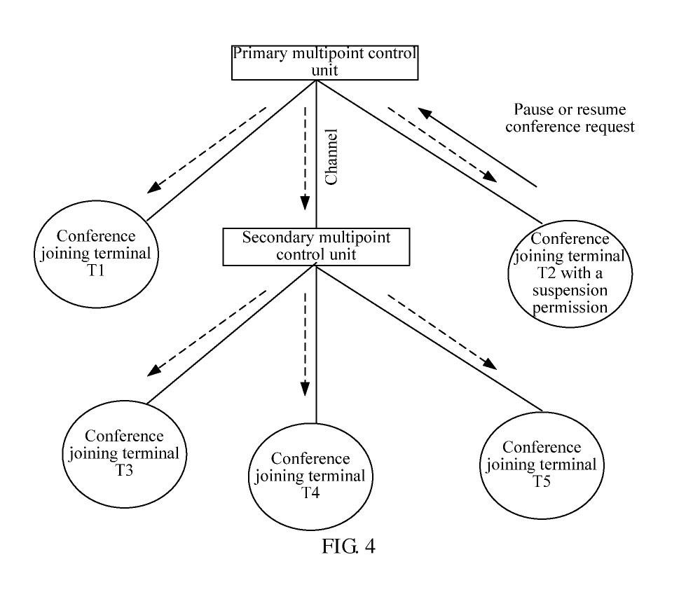

In this embodiment, there may be multiple media channels between the conference joining terminals and the MCU, and each media channel can be used to send or receive media code streams. After receiving the pause conference indication information sent by the MCU, the conference joining terminals disable their media channels and save channel parameters, where the channel parameters include audio and video formats, selectable audio and video encoding types, audio and video rates, communication rates, and the like. As shown in FIG. 4, there is one channel between a conference joining terminal T1 and a primary MCU, and the channel is used to send or receive media code streams. After the T1 receives pause conference indication information sent by the MCU, the T1 disables the channel.

In an embodiment of the present invention, after the conference joining terminal with the suspension permission sends the pause request information to the MCU, the MCU sends response information to the conference joining terminal with the suspension permission, and then sends pause conference indication information to the other conference joining terminals. After receiving the response information, the conference joining terminal with the suspension permission disables its media channel, saves channel parameters, and enters a standby or hibernation state, while after receiving the pause conference indication information, the other conference joining terminals disable their media channels, save channel parameters, and enter the standby or hibernation state.

In this embodiment, to prevent operating power consumption of the conference joining terminals, all the conference joining terminals enter the standby or hibernation state after disabling media sending or receiving channels and saving channel parameters. It should be noted that, when the conference joining terminals are complex, for example, multiple central processing units (CPUs) exist, only a primary CPU operates; digital signal processors (DSPs) and external devices enter the hibernation state. Certainly, the primary CPU may also be forced to enter the hibernation state.

Preferably, to ensure that a conference can still be reconvened successfully after being suspended in circumstances such as a power failure, the conference joining equipment in this embodiment still save conference parameters of the current conference after receiving the pause conference indication information, where the conference parameters include currently viewed images of the conference joining terminals (for example, the conference joining terminal T1 outputs images of conference joining terminals T3 and T4, or the conference joining terminal T1 chooses to view an image of a conference joining terminal T2), whether the suspension permission is granted, and the like.

In another embodiment of the present invention, the method further includes after the MCU sends the pause conference indication information to all the conference joining terminals, disabling the media channels of the MCU, and saving the channel parameters, data of the current conference, and states of each conference joining terminal.

In this embodiment, the conference data includes conference parameters of all the conference joining terminals; the channel parameters includes parameters of the channels connecting the MCU to all the conference joining terminals; the states of each conference joining terminal include states such as broadcasting, viewing, roll call, speaking. It should be noted that, after sending the pause conference indication information to all the conference joining terminals, the MCU saves the data of the current conference, and then the conference parameters saved by the conference joining terminals in this embodiment are equivalent to a backup of the conference data. Certainly, the data of the current conference saved by the MCU may also be used as a backup of the conference parameters of the conference joining terminals, with a same purpose of ensuring that the conference can be successfully reconvened after being suspended.

3. The multipoint control unit MCU sends resume conference indication information to the conference joining terminals.

In this embodiment, the MCU sends, according to the extended conference control information shown in Table 1, resume conference indication information to each conference joining terminal to implement resumption after conference suspension. It should be noted that, if the media channels of the MCU are disabled, before the MCU sends the resume conference indication information to the conference joining terminals, the media channels of the MCU need to be enabled first.

Preferably, among the conference joining terminals, the conference joining terminal with the suspension permission may send resume conference request information to the MCU at any time. After receiving the resume conference request information sent by the conference joining terminal with the suspension permission, the MCU enables its media channels (in a situation in which its media channels are disabled) and sends resume conference indication information to all or a part of the conference joining terminals (as shown in FIG. 4). It should be noted that, all the conference joining terminals include the conference joining terminal with the suspension permission.

That the conference joining terminal with the suspension permission among the conference joining terminals sends the resume conference request information to the MCU is the conference joining terminal with the suspension permission among the conference joining terminals sends the resume conference request information to the MCU, where the resume conference request information carries the conference identification information of the conference that needs to be resumed; or, the conference joining terminal with the suspension permission among the conference joining terminals sends the resume conference request information to the MCU, where the resume conference request information carries the identifier of one or more conference joining terminals for which the conference needs to be resumed; or, the conference joining terminal with the suspension permission among the conference joining terminals sends the resume conference request information to the MCU, where the resume conference request information carries the identifier and conference identification information of the one or more conference joining terminals for which the conference needs to be resumed.

Preferably, the MCU may further preset a resume time or set a resume time when a conference is suspended. When the preset resume time elapses, the media channels of the MCU are enabled to send the resume conference indication information to all or a part of the conference joining terminals.

It should be noted that, except the conference joining terminal with the suspension permission or the MCU, the other conference joining terminals do not have a permission to resume the conference.

4. After receiving the resume conference indication information, the conference joining terminals enable their media channels according to the pre-saved channel parameters.

In this embodiment, because each conference joining terminal saves its corresponding channel parameters when the conference is suspended, after receiving the resume conference indication information, each conference joining terminal enables a corresponding media channel according to the stored channel parameters, so as to continue receiving or sending media code streams, and resume the suspended conference.

In this embodiment, after a conference is suspended, the conference may be quickly resumed by using a conference joining terminal with a suspension permission or an MCU to send conference control signaling. Operations are simple and practicability is relatively high.

In this embodiment, when the MCU controls multiple conferences at the same time and only one of the conferences needs to be suspended or resumed, the MCU may suspend or resume the one conference according to pre-stored conference information, or identify all conference joining terminals related to the requesting terminal with the permission and send a suspend or resume conference indication to only the terminals, or carries, when sending a suspend or resume indication to all the terminals, identifications of the terminals in the indication, so as to facilitate suspension or resumption control over the selected conference joining terminals, where the conference information includes a conference identification and information about the conference joining terminals related to the conference.

For example, as shown in FIG. 4, the conference joining terminal T2 with the suspension permission sends pause conference request information to the MCU, where the pause conference request information carries unique identifiers T1 and T2 of conference joining terminals for which the conference needs to be suspended. In other words, conference suspension is implemented for the conference joining terminals T1 and T2. After receiving the pause conference request information that carries the unique identifiers, the MCU sends pause conference indication information to the conference joining terminals T1 and T2. When receiving the pause conference indication information, the conference joining terminals T1 and T2 disable their media channels, save channel parameters, and enter the standby or hibernation state. The conference joining terminal T2 with the suspension permission sends resume conference request information to the MCU, where the resume conference request information carries the unique identifiers T1 and T2 of the conference joining terminals for which the conference needs to be resumed. In other words, conference resuming is implemented for the conference joining terminals T1 and T2. After receiving the resume conference request information that carries the unique identifiers, the MCU sends resume conference indication information to the conference joining terminals T1 and T2. When receiving the resume conference indication information sent by the MCU, the conference joining terminals T1 and T2 enable their media channels and resume the working state according to the saved channel parameters.

### Embodiment 4

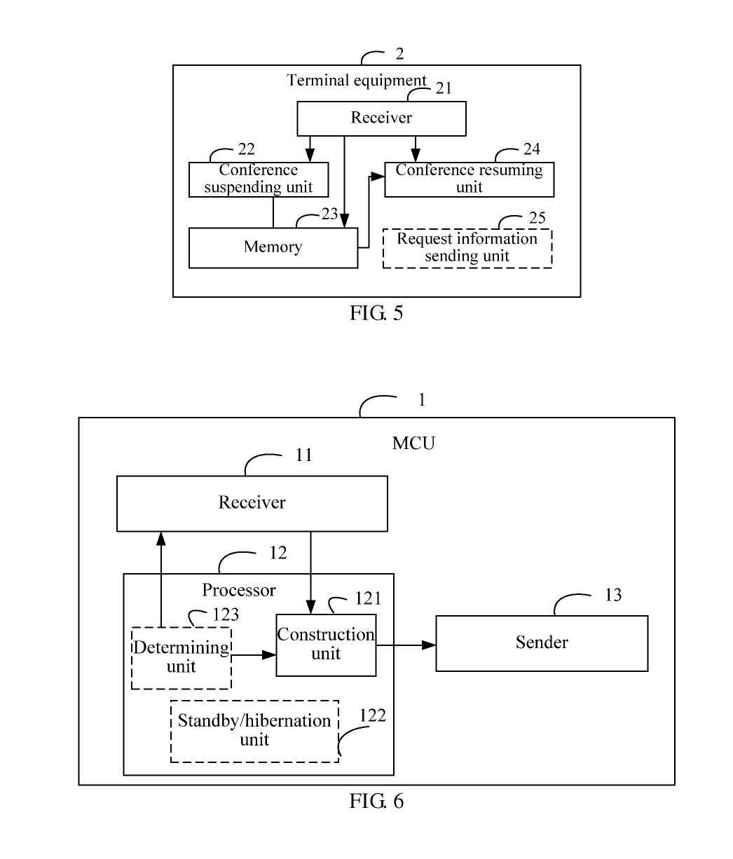

FIG. 5 shows a composition structure of a terminal equipment according to Embodiment 4 of the present invention. For ease of description, only a part related to this embodiment of the present invention is shown.

The terminal equipment may be a hardware unit or a unit combining software and hardware that operates in various video conferencing systems.

The terminal equipment 2 includes a receiver 21, a conference suspending unit 22, a memory 23, and a conference resuming unit 24, and their functions are as follows:

The receiver 21 is configured to receive pause conference indication information or resume conference indication information from an MCU; the conference suspending unit 22 is configured to when the receiver 21 receives the pause conference indication information from the MCU, disable a media channel of the current terminal equipment according to the received pause conference indication information, and enable the current terminal equipment 2 to enter a standby or hibernation state; the memory 23 is configured to save channel parameters of a current conference; and the conference resuming unit 24 is configured to when the receiver 21 receives the resume conference indication information from the MCU, enable the media channel of the current terminal equipment 2 according to the received resume conference indication information and the channel parameters saved in the memory 23, and resume the working state of the current terminal equipment 2.

Further, the memory 23 is further configured to save conference parameters and store a current state of the terminal equipment 2, where the current state includes the hibernation or standby state or a working state.

Preferably, when the terminal equipment 2 is a terminal equipment with a suspension permission, the terminal equipment 2 further includes a request information sending unit 25 configured to send the pause or resume conference request information to the MCU to enable the MCU to send the pause or resume conference indication information to all or a part of conference joining terminals; the conference suspending unit 22 is configured to when the receiver 21 receives the pause conference indication information from the MCU, determine whether an identifier of a conference joining terminal carried in the pause conference indication information is the same as an identifier of the current terminal, or determine whether conference identification information carried in the pause conference indication information is the same as a conference identification of a conference currently joined by the current terminal, or determine whether the conference identification information carried in the pause conference indication information is the same as the conference identification of the conference currently joined by the current terminal and whether the identifier of a conference joining terminal carried in the pause conference indication information is the same as the identifier of the current terminal; if yes, then, disable the media channel of the current terminal equipment according to the received pause conference indication information, and enable the current terminal equipment to enter the standby or hibernation state; and the conference resuming unit 24 is configured to when the receiver 21 receives the resume conference indication information from the MCU, determine whether the identifier of a conference joining terminal carried in the resume conference indication information is the same as the identifier of the current terminal, or determine whether the conference identification information carried in the resume conference indication information is the same as the conference identification of the conference currently joined by the current terminal, or determine whether the conference identification information carried in the resume conference indication information is the same as the conference identification of the conference currently joined by the current terminal and whether the identifier of a conference joining terminal carried in the resume conference indication information is the same as the identifier of the current terminal; if yes, then, enable the media channel of the current terminal equipment according to the received resume conference indication information and the channel parameters saved in the memory, and resume the working state of the current terminal equipment.

In this embodiment, the pause conference request information, the resume conference request information, the pause conference indication information, and the resume conference indication information are predefined extended conference control information.

The terminal equipment provided in this embodiment may use the foregoing corresponding remote conference control method. For details, refer to related description of the foregoing remote conference control methods in Embodiments 2 and 3. Details are not described herein again.

### Embodiment 5

FIG. 6 shows a composition structure of an MCU according to Embodiment 5 of the present invention. For ease of description, only a part related to this embodiment of the present invention is shown.

The MCU may be a hardware unit or a unit combining software and hardware that operates in various video conferencing systems.

The MCU 1 includes a receiver 11, a processor 12, and a sender 13, and the processor 12 includes a construction unit 121, where their functions are as follows:

The receiver 11 is configured to receive pause conference request information or resume conference request information; the processor 12 includes the construction unit 121, where the construction unit 121 is configured to construct a pause conference indication according to the pause conference request information received by the receiver 11; construct a resume conference indication according to the resume conference request information received by the receiver 11; and the sender 13 is configured to send the pause conference indication or the resume conference indication constructed by the construction unit 121.

Further, the construction unit 121 is configured to determine whether the pause conference request information or the resume conference request information received by the receiver 11 carries a conference identification; if the pause conference request information or the resume conference request information received by the receiver 11 carries a conference identification, acquire information about all conference joining terminals of a conference corresponding to the conference identification; and construct the pause or resume conference indication, where the pause or resume conference indication carries information about all the conference joining terminals of the conference corresponding to the conference identification; and determine whether the pause conference request information or the resume conference request information received by the receiver 11 carries an identification of one or more conference joining terminals; and if the pause conference request information or the resume conference request information received by the receiver 11 carries an identification of one or more conference joining terminals, construct the pause or resume conference indication that carries the identification of the one or more conference joining terminals.

Further, the processor 12 further includes a hibernation/standby unit 122 configured to after the pause conference indication information is sent to all the terminal equipment, disable media channels of the current MCU, and save channel parameters, data of the current conference, and states of all the current conference joining terminals, where the channel parameters include parameters of channels connecting the current multipoint control unit to all the terminal equipment and the data of the current conference includes conference parameters of all the terminal equipment.

Further, the processor 12 further includes a determining unit 123, where the determining unit 123 is configured to determine a permission of a requester of the information received by the receiver 11, and if the information is sent by a terminal with the permission, trigger the construction unit 121 to implement assembling.

In this embodiment, the pause conference request information, the resume conference request information, the pause conference indication information, and the resume conference indication information are predefined extended conference control information.

The MCU provided in this embodiment may use the foregoing corresponding remote conference control method. For details, refer to related description of the foregoing remote conference control method in Embodiment 3. Details are not described herein again.

A person of ordinary skill in the art may understand that all the units included in Embodiments 4 and 5 are only divided according to functional logic and are not limited to the foregoing division if only the corresponding functions can be implemented; furthermore, the specific names of all the units are also only for convenience of distinguishing between them, but are not used to limit the protection scope of the present invention.

In conclusion, the embodiments of the present invention use a means of suspending a conference instead of a means of ending a conference, and a problem that a conference joining site may be called by another conference or site and configuration parameters of the site are changed does not exist, ensuring successful reconvening of the conference; an MCU or any one of conference joining terminals with a suspension permission sends conference control signaling to quickly and simply implement conference suspension and resumption, so as to suspend the conference at any time and resume the conference at any time; during suspension of the conference, all media sending or receiving channels are disabled and all the conference joining devices enter a standby or hibernation state. In this way, bandwidth resources are not occupied and loss of the conference joining devices is prevented, featuring good usability and high practicality.

A person of ordinary skill in the art may also understand that all or a part of the steps of the methods in the embodiments may be implemented by a program instructing relevant hardware. The program may be stored in a computer readable storage medium. The storage medium includes: a ROM (read-only memory), a RAM (random access memory), a magnetic disk, and/or an optical disc.

The foregoing descriptions are merely exemplary embodiments of the present invention, but are not intended to limit the present invention. Any modification, equivalent replacement, or improvement made without departing from the spirit and principle of the present invention should fall within the protection scope of the present invention.

What is claimed is:

1. A remote conference control method, wherein the method comprises:
disabling, by conference joining terminals according to a received pause conference indication information, media channels of the conference joining terminals, saving channel parameters;
entering a standby or hibernation state when the conference joining terminals receive pause conference indication information sent by a multipoint control unit (MCU) during a process of a video conference;
enabling, by conference joining terminals according to a received resume conference indication information and the saved channel parameters, the media channels of the conference joining terminals; and
resuming a working state when the conference joining terminals receive the resume conference indication information sent by the MCU.

2. The method according to claim 1, wherein the method further comprises sending, by a conference joining terminal with a suspension permission among the conference joining terminals, pause or resume conference request information to the MCU to enable the MCU to send the pause or resume conference indication information to at least part of the conference joining terminals, wherein the pause or resume conference request information is predefined conference control information.

3. The method according to claim 2, wherein sending the pause or resume conference request information to the MCU comprises sending, by the conference joining terminal with the suspension permission among the conference joining terminals, the pause or resume conference request information to the MCU, and wherein the pause or resume conference request information carries conference identification information of a conference that needs to be suspended or resumed.

4. The method according to claim 2, wherein sending the pause or resume conference request information to the MCU comprises sending, by the conference joining terminal with the suspension permission among the conference joining terminals, the pause or resume conference request information to the MCU, and wherein the pause or resume conference request information carries an identifier of one or more conference joining terminals for which the conference needs to be suspended or resumed.

5. The method according to claim 2, wherein sending the pause or resume conference request information to the MCU comprises sending, by the conference joining terminal with the suspension permission among the conference joining terminals, the pause or resume conference request information to the MCU, and wherein the pause or resume conference request information carries an identifier and conference identification information of the one or more conference joining terminals for which the conference needs to be suspended or resumed.

6. The method according to claim 1, wherein after the conference joining terminals receive the pause conference indication information sent by the MCU, the method further comprises saving conference parameters.

7. A terminal equipment comprising:
a receiver configured to receive pause conference indication information or resume conference indication information from a multipoint control unit (MCU);
a conference suspending unit configured to:
disable a media channel of the current terminal equipment according to the received pause conference indication information when the receiver receives the pause conference indication information from the MCU; and
enable the current terminal equipment to enter a standby or hibernation state;
a memory configured to save channel parameters of a current conference; and
a conference resuming unit configured to:
enable the media channel of the current terminal equipment according to the received resume conference indication information and the channel parameters saved in the memory when the receiver receives the resume conference indication information from the MCU; and
resume a working state of the current terminal equipment.

8. The terminal equipment according to claim 7, wherein the memory is further configured to save conference parameters.

9. The terminal equipment according to claim 7, further comprising a request information sending unit configured to send the pause conference request information or the resume conference request information to the MCU to enable the MCU to send the pause or resume conference indication information to at least part of conference joining terminals, wherein the pause or resume conference request information is predefined conference control information.

10. The terminal equipment according to claim 7, wherein the conference suspending unit is further configured to:
determine whether an identifier of a conference joining terminal carried in the pause conference indication information is the same as the identifier of the current terminal when the receiver receives the pause conference indication information from the MCU;
disable a media channel of the current terminal equipment according to the received pause conference indication information when the identifier of the conference joining terminal carried in the pause conference indication information is the same as the identifier of the current terminal; and
enable the current terminal equipment to enter a standby or hibernation state.

11. The terminal equipment according to claim 7, wherein the conference suspending unit is further configured to:
determine whether the conference identification information carried in the pause conference indication information is the same as a conference identification of a conference currently joined by the current terminal when the receiver receives the pause conference indication information from the MCU;
disable a media channel of the current terminal equipment according to the received pause conference indication information when the conference identification information carried in the pause conference indication information is the same as the conference identification of the conference currently joined by the current terminal; and
enable the current terminal equipment to enter a standby or hibernation state.

12. The terminal equipment according to claim 7, wherein the conference suspending unit is further configured to:
determine whether the conference identification information carried in the pause conference indication information is the same as the conference identification of the conference currently joined by the current terminal and whether an identifier of the conference joining terminal carried in the pause conference indication information is the same as the identifier of the current terminal when the receiver receives the pause conference indication information from the MCU;
disable a media channel of the current terminal equipment according to the received pause conference indication information when the conference identification information carried in the pause conference indication information is the same as the conference identification of the conference currently joined by the current terminal and when an identifier of the conference joining terminal carried in the pause conference indication information is the same as the identifier of the current terminal; and
enable the current terminal equipment to enter a standby or hibernation state.

13. The terminal equipment according to claim 7, wherein the conference resuming unit is further configured to:
determine whether an identifier of a conference joining terminal carried in the resume conference indication information is the same as the identifier of the current terminal when a receiver receives the resume conference indication information from the MCU;
enable a media channel of the current terminal equipment according to the received resume conference indication information and the channel parameters saved in the memory when the identifier of the conference joining terminal carried in the resume conference indication information is the same as the identifier of the current terminal; and
resume the working state of the current terminal equipment.

14. The terminal equipment according to claim 7, wherein the conference resuming unit is configured to:
determine whether the conference identification information carried in the resume conference indication information is the same as the conference identification of the conference currently joined by the current terminal when a receiver receives the resume conference indication information from the MCU;
enable a media channel of the current terminal equipment according to the received resume conference indication information and the channel parameters saved in a memory when the conference identification information carried in the resume conference indication information is the same as the conference identification of the conference currently joined by the current terminal; and
resume the working state of the current terminal equipment.

15. The terminal equipment according to claim 7, wherein the conference resuming unit is configured to:
determine whether the conference identification information carried in the resume conference indication information is the same as the conference identification of the conference currently joined by the current terminal and whether the identifier of a conference joining terminal carried in the resume conference indication information is the same as an identifier of the current terminal when a receiver receives the resume conference indication information from the MCU;
enable a media channel of the current terminal equipment according to the received resume conference indication information and the channel parameters saved in a memory when the conference identification information carried in the resume conference indication information is the same as the conference identification of the conference currently joined by the current terminal and when the identifier of a conference joining terminal carried in the resume conference indication information is the same as the identifier of the current terminal; and
resume the working state of the current terminal equipment.

16. A video conferencing system comprising:
a multipoint control unit and
at least three terminal equipment, wherein the multipoint control unit and the terminal equipment are connected by using a network, and wherein the multipoint control unit comprises:
a receiver configured to receive pause conference request information or resume conference request information;
a processor comprising a construction unit, wherein the construction unit is configured to:
construct a pause conference indication according to the pause conference request information received by the receiver; and
construct a resume conference indication according to the resume conference request information received by the receiver; and
a sender configured to send the pause conference indication or the resume conference indication constructed by the construction unit.

17. The video conferencing system according to claim 16, wherein the terminal equipment comprise terminal equipment with a suspension permission configured to send the pause or resume conference request information to the multipoint control unit.

18. The video conferencing system according to claim 16, wherein the construction unit is configured to:
construct the pause conference indication according to the pause conference request information received by the receiver;
construct the resume conference indication according to the resume conference request information received by the receiver;
determine whether the pause conference request information or the resume conference request information received by the receiver carries a conference identification;
acquire information about all conference joining terminals of a conference corresponding to the conference identification if the pause conference request information or the resume conference request information received by the receiver carries a conference identification;
construct the pause or resume conference indication, wherein the pause or resume conference indication carries the information about all the conference joining terminals of the conference corresponding to the conference identification;
determine whether the pause conference request information or the resume conference request information received by the receiver carries an identifier of one or more conference joining terminals; and
construct the pause or resume conference indication that carries the identification of the one or more conference joining terminals if the pause conference request information or the resume conference request information received by the receiver carries an identification of the one or more conference joining terminals.

19. The video conferencing system according to claim 16, wherein the processor further comprises a hibernation/standby unit configured to:
disable a media channel of the current MCU after the pause conference indication information is sent to all the terminal equipment; and
save channel parameters, data of a current conference, and states of all current conference joining terminals, wherein the channel parameters comprise parameters of channels connecting the current multipoint control unit to all the terminal equipment and the data of the current conference comprises conference parameters of all the terminal equipment.

20. A multipoint control unit (MCU), wherein the MCU comprises:
a receiver configured to receive pause conference request information or resume conference request information;
a processor comprising a construction unit, wherein the construction unit is configured to:
construct a pause conference indication according to the pause conference request information received by the receiver; and
construct a resume conference indication according to the resume conference request information received by the receiver; and
a sender configured to send the pause conference indication or the resume conference indication constructed by the construction unit.

21. The MCU according to claim 20, wherein the processor further comprises a determining unit, wherein the determining unit is configured to:
determine a permission of a requester of information received by the receiver; and
trigger the construction unit to implement assembling if the information is sent by a terminal with a permission.
